(19) United States
(12) Patent Application Publication
(10) Pub. No.: US 2004/0117457 A1
(43) Pub. Date: Jun. 17, 2004

(54) E-mail systems

(76) Inventor: Brian Dorricott, Clevedon (GB)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/637,118

(22) Filed: Aug. 8, 2003

(30) Foreign Application Priority Data
Aug. 9, 2002 (GB) 0218431.5

(51) Int. Cl. G06F 15/16

(52) U.S. Cl. 709/217

(57) ABSTRACT

Users' e-mail accounts are transferred from a source server to a destination server by setting up the destination server so that it acts as a gateway transferring e-mail connections to the source server and then transferring users' mail folders from the source server to the destination server. The destination server can be set up as a gateway using a router to route TCP connections to the user's e-mail account via the destination server. Preferably, the destination server is set up by allocating it the same IP address as the source server and the source server is allocated a new IP address so that e-mail connections are routed to the destination server. Log in of each user to the destination server for the first time initiates the transfer of their mail folder and its contents from the source server to the destination server, either immediately or after the user has logged off. Thereafter, when that user logs in, the destination server handles that user's access locally.

### TECHNICAL FIELD

The disclosed method and apparatus relates to transferring users' e-mail accounts from one mail system to another.

### BACKGROUND

The transfer of e-mail accounts to a new system is normally the responsibility of an administrator who has to transfer the associated mail folders and their contents from the old system to the new system before the new system is switched on and users are allowed to use it with reissued passwords. However, there are a number of difficulties that may arise in transferring e-mail accounts from one system to another including the lack of a listing of the accounts on the old system, the need to convert mail folder contents from one proprietor format to another, encrypted passwords and legal issues in decrypting or analyzing the file formats of proprietary systems. Therefore, the transfer of e-mail accounts from one system to another can be complicated and involves a risk of a loss of e-mail services during the transfer process.

### SUMMARY

Users' e-mail accounts are transferred from a source server to a destination server by setting up the destination server so that it acts as a gateway transferring e-mail connections to the source server and then transferring users' mail folders from the source server to the destination server.

The destination server can be set up as a gateway using a router to route TCP connections to the user's e-mail account via the destination server. Preferably, however, the destination server is set up by allocating it the same IP address as the source server and the source server is allocated a new IP address so that e-mail connections are routed through the destination server. In either arrangement, log in of each user to the destination server for the first time initiates the transfer of their mail folder and its contents from the source server to the destination server, either immediately or after the user has logged off. Thereafter, when that user logs in the destination server handles that user's access locally. When the transfer of mail folders take place immediately, the user may experience a slight delay before receiving service, but when the transfer takes place after the user has logged off, the mail connections are passed through to the source server without any delay, and the next time the user logs in, the destination server handles the account locally.

Therefore, the disclosed method and system allows e-mail accounts to be ported from one proprietary system to another without the need to make any changes to the source server. The administrator does not need to contact users in order to change their passwords, and the transfer of mail files takes place automatically. Furthermore, the e-mail service is not disrupted and users do not have to disclose or change their passwords or change the configuration of mail clients. The transfer process between the destination server and the source server will work with any Internet Standards-Compliant messaging server as the source server including those supporting POP3 or IMAP4 or SMTP Protocols.

### BRIEF DESCRIPTION OF THE DRAWINGS

FIG. 1 is a schematic diagram illustrating a standard Internet mail server; and

FIG. 2 is a schematic diagram illustrating a destination server and source server set up according to an example of the disclosed system and method to transfer user e-mail accounts between them.

### DETAILED DESCRIPTION

In the illustrated example, there are three phases to transferring the accounts from the source server 1 to the to destination server 2: i) Preparation, ii) Account Transfer, and iii) Retiring the Source Server. The Account Transfer phase could last several weeks to ensure that all accounts are transferred successfully, but this time would cover the period that employees may be on holiday/vacation.

Phase i)—Preparation

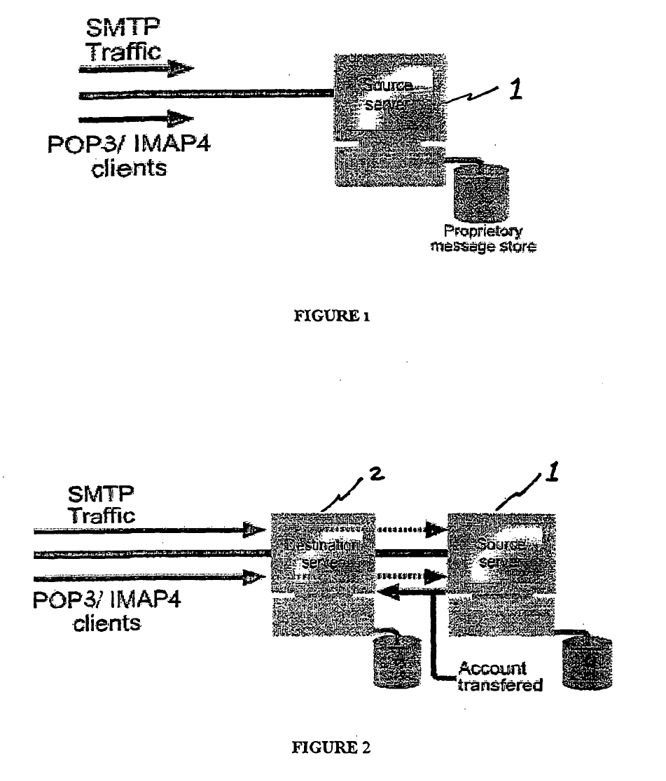

Before transfer is actioned, the source server 1 is typically providing e-mail to people via the Internet as shown in FIG. 1.

The destination server 2 is prepared, off the network, by having the new messaging server software installed, setting it up for porting, and giving it the same IP address as the source server 2. In setting up for porting, the destination server 2 is configured to serve as a gateway to transfer all POP3, SMTP and IMAP4 connections through to the source server (which will later be moved to a new IP address).

Phase ii)—Account Transfer

To begin the porting process, the source server 1 is taken off-line and given the new IP address. The destination server 2 is connected to the network (preferably on the same LAN segment), and the source server 1 restarted. Users can continue to collect and send e-mail in the usual way as illustrated in FIG. 2.

When a user logs in to the destination server 2 for the first time, it collects the account information (e.g. user name and password). There are then two different strategies for transferring the user's mail folder and its contents from the source system 1 to the destination server 2. In the first strategy, the destination server 2 acts as a gateway for the source server 1. When the user logs off, the destination server 2 logs on to the source server 1 (by IMAP4 or POP3) and transfers all the user's folder contents to the destination server and then marks the account as transferred.

In the second strategy, as soon as the destination server 2 has the account information, it logs on to the source server 1 and initiates the transfer of mail folder and its contents. During this transfer, the user will perceive a slight delay, although this is unlikely to be large due to the proximity of the two servers.

Subsequent log-on's by the user are handled by the destination server 2 directly.

Over a period of time (the duration of which is defined by the system administrator responsible for the portation process), all live accounts will have been transferred automatically to the destination server 2 without any interruption of service to users. After this specified period, the administrator can retire the source server 1 secure in the knowledge that all live accounts are on the destination server 2.

To show how this works the Internet Messaging Protocols are examined in more detail.

Post Office Protocol v3—POP3 This protocol is defined by Internet Standard RFC1939 and defines how mail clients collect e-mail from a messaging server. When a POP3 client connects to the destination server 2, the system checks to see if the account is being managed locally. If the account is local, it must have been transferred previously, so the destination server 2 handles the account without reference to the source server 1.

If the account is not held on the destination server 2, there are two strategies for transferring folder information. In the first strategy, the destination server 2 will automatically log in to the source server 1 and act as a gateway feeding all communications between the client and source server. As far as the client and source servers are concerned, they are still communicating with each other. The destination server 2 will keep a copy of the user name and password, encrypt them, and notes that the transfer operation needs to take place.

The second strategy involves the destination server 2 connecting to the source server 1 and logging on with the user name and password. A transfer of all folder information is immediately started (while the client is waiting). Once the information has been transferred IMAP4 This protocol is defined by Internet Standard RFC2060 and defines how mail clients collect e-mail from a messaging server. The procedure for managing IMAP4 connections is exactly the same as for POP3 connections.

The Simple Mail Transfer Protocol: SMTP This protocol manages e-mail messages arriving at the server. When the destination server 2 is first installed, it acts as a gateway server delivering all e-mail to the source server 1. As soon as a user logs in through POP3 or IMAP4 and an account is transferred to the destination server, all future e-mail for that account is delivered locally. Over a period of time, the number of messages forwarded to the source server will decrease as more and more accounts are transferred.

The transfer process could take place at two different times (depending upon the chosen strategy) but the process is the same in both cases.

The destination server 2 creates a local account for the user and marks it as “not in service”. If the account owner attempts to log into the account they will be told the server is currently busy and that they should try later. Likewise, any e-mail for that account will be held off by responding with a “retry later” command.

The destination server 2 logs into the IMAP4 service of source server 1 with the user name and password of the account to be transferred. Using the IMAP4 protocol, the destination server 2 enumerates all the folders on the source server 1 and copies each folder and its contents (including any additional message information, e.g. draft messages, etc.).

If the source server 1 does not support the IMAP4 protocol, the destination server 2 may connect to the source server using POP3 and transfer the inbox.

When all the folders have been transferred, the destination server 2 logs off from the source server 1 and marks the local account as “in service”. Any future attempts by the account owner to read e-mail will now be serviced by the destination server 2. E-mail for the account can now be delivered.

The transfer process is largely transparent to the user firstly because the transfer time is likely to be small since the folders are transferred between two machines on a high bandwidth link, and secondly because the transfer may take place after a user has just finished checking their e-mail. This means that there is usually a period of time for the account to be transferred when the user is no longer accessing their e-mail.

Phase iii): Retiring Source Server

After a period of time (e.g. a month), the system administrator may determine that it is time to retire the source server 1. Some special mail routing rules (e.g. forwards, auto-automatically. By reviewing the log of messages that are still being forwarded to the source server 1, these special rules can be identified and appropriate action taken.

Although preferred examples have been disclosed for illustrative purposes, those of ordinary skill in the art will appreciate that the scope of this patent is not limited thereto. On the contrary this patent covers all systems and methods falling within the scope and spirit of the accompanying claims.

What is claimed is:

1. A method of transferring users' e-mail accounts from a source server to a destination server, the method comprising:
setting up the destination server to act as a gateway transferring e-mail connections to the source server; and
transferring users' mail folders from the source server to the destination server.

2. A method as claimed in claim 1, wherein setting up the destination server comprises allocating the destination server the same IP address as the source server, the method further comprising allocating the source server a new IP address.

3. A method as claimed in claim 2, further comprising retiring the source server once all e-mail accounts have been transferred.

4. A method as claimed in claim 1, further comprising routing mail connections to users' e-mail accounts via the destination server with a router.

5. A method as claimed in claim 4, further comprising retiring the source server once all e-mail accounts have been transferred.

6. A method as claimed in claim 1, wherein setting up the destination server comprises setting up the destination server to initiate the transfer of the user's mail folder and its contents from the source server to the destination server when each user logs on for the first time.

7. A method as claimed in claim 6, wherein setting up the destination server comprises allocating the destination server the same IP address as the source server, the method further comprising allocating the source server a new IP address.

8. A method as claimed in claim 7, further comprising retiring the source server once all e-mail accounts have been transferred.

9. A method as claimed in claim 6, further comprising routing mail connections to users' e-mail accounts via the destination server with a router.

10. A method as claimed in claim 9, further comprising retiring the source server once all e-mail accounts have been transferred.

11. A method as claimed in claim 6, further comprising initiating the transfer of the user's mail folder when each user logs on for the first time before the destination server services the user.

12. A method as claimed in claim 11, wherein setting up the destination server comprises allocating the destination server the same IP address as the source server, the method further comprising allocating the source server a new IP address.

13. A method as claimed in claim 12, further comprising retiring the source server once all e-mail accounts have been transferred.

14. A method as claimed in claim 11, further comprising routing mail connections to users' e-mail accounts via the destination server with a router.

15. A method as claimed in claim 14, further comprising retiring the source server once all e-mail accounts have been transferred.

16. A method as claimed in claim 6, further comprising:
causing the destination server to pass the e-mail connection through to the source server when each user logs on for the first time; and
transferring the user's mail folder once the user has logged off.

17. A method as claimed in claim 16, wherein setting up the destination server comprises allocating the destination server the same IP address as the source server, the method further comprising allocating the source server a new IP address.

18. A method as claimed in claim 17, further comprising retiring the source server once all e-mail accounts have been transferred.

19. A method as claimed in claim 16, further comprising routing mail connections to users' e-mail accounts via the destination server with a router.

20. A method as claimed in claim 19, further comprising retiring the source server once all e-mail accounts have been transferred.

21. An apparatus for transferring users' e-mail accounts from a source server to a destination server, the apparatus comprising:
a source server on which is set up the e-mail accounts; and
a destination server arranged to receive e-mail accounts as they are transferred from the source server, arranged as a gateway transferring e-mail connections to the source server, and further arranged to initiate transfer of users' mail folders as they each log in.

22. A computer program product for transferring users' e-mail accounts from a source server to a destination server, the computer program product comprising a computer readable program code configured to cause the destination server to act as a gateway transferring e-mail connections to the source server, and further configured to transfer users' e-mail folders from the source server to the destination server.
